(19) United States
(12) Patent Application Publication
(10) Pub. No.: US 2023/0132700 A1
(43) Pub. Date: May 4, 2023

(54) HYDROGEL FLUID DEVICE AND METHOD FOR MANUFACTURING HYDROGEL FLUID DEVICE

(71) Applicant: NIPPON TELEGRAPH AND TELEPHONE CORPORATION, Tokyo (JP)

(72) Inventors: Riku TAKAHASHI, Musashino-shi, Tokyo (JP); Aya TANAKA, Musashino-shi, Tokyo (JP); Yuko UENO, Musashino-shi, Tokyo (JP)

(73) Assignee: NIPPON TELEGRAPH AND TELEPHONE CORPORATION, Tokyo (JP)

(21) Appl. No.: 17/768,208

(22) PCT Filed: Oct. 21, 2019
(86) PCT No.: PCT/JP2019/041262

§ 371 Date: Apr. 11, 2022

(51) Int. Cl. C08J 9/228; C08J 5/18; C08J 9/00

(52) U.S. Cl. CPC C08J 9/228; C08J 5/18; C08J 9/0004; C08J 2205/022

(57) ABSTRACT

There are provided a hydrogel fluid device which includes a flow path having an arbitrary shape that can be formed by a simple method and in which a material of a base component can be arbitrarily selected and the mechanical strength is excellent when the flow path is processed, and a method of producing the same. A hydrogel fluid device 1 includes a film hydrogel 3 having an adhesive area 3a for a base component 2 and a non-adhesive area 3b for the base component 2, a flow path 4 that is formed due to swelling of the hydrogel constituting the non-adhesive area 3b, and a bulk gel 5 that covers one surface of the film hydrogel 3 outside the flow path 4 and composed of a polymer material having a lower degree of swelling than the hydrogel before swelling; and a method of producing a hydrogel fluid device includes providing a layer of a hydrogel on the base component 2 so that the adhesive area 3a for the base component 2 and the non-adhesive area 3b for the base component 2 are formed, forming the flow path 4 by swelling the hydrogel, covering the outside of the flow path 4 with a polymer material having a lower degree of swelling than the hydrogel before swelling, and swelling the bulk polymer material.

### TECHNICAL FIELD

The present invention relates to a hydrogel fluid device and a method of producing a hydrogel fluid device.

### BACKGROUND ART

Hydrogels are known. Hydrogels have properties such as biocompatibility, high water content, high flexibility, high lubricity, and allowing permeability with respect to substances. These properties of hydrogels are similar to properties of biological tissues. Therefore, hydrogels are suitable as materials for devices that artificially reproduce biological systems.

It has been proposed that a hydrogel be molded into a three-dimensional shape, for example, a hollow shape, to form a flow path. For example, the construction of a biological system in which a liquid is poured into a flow path formed of a hydrogel, and a substance in the liquid can be exchanged between the flow path and the hydrogel is being studied. Biological systems using hydrogels are expected to be used in various industrial fields such as medical treatment, cell culture, and robotics.

As a technique for forming a flow path with a hydrogel, for example, the method in NPL 1 is known. NPL 1 discloses a method of forming a flow path in a hydrogel by combining 3D printing and a sacrificial layer. However, in the method disclosed in NPL 1, material alternatives are limited, and not just any base component can be used. In addition, the minimum size of the flow path to be formed is on the millimeter scale, and there are restrictions on the selection of the shape of the flow path. In addition, the method disclosed in NPL 1 is not a simple method because the process of removing the sacrificial layer is complicated.

Here, the inventors have disclosed the method described in NPL 2 as a method of forming a flow path formed of a hydrogel. For example, as shown in FIGS. 28 and 29, in the method described in NPL 2, an adhesive area 103a and a non-adhesive area 103b of an arbitrary base component 102 and a hydrogel 103 are arranged in an arbitrary pattern. A device 100 including a flow path 104 (hereinafter, referred to as a “hybrid flow path” in some cases) containing a hydrogel with an arbitrary shape can be easily formed as a micrometer-scale microstructure by allowing free swelling of the thin film of the hydrogel 103 of the non-adhesive area 103b.

### CITATION LIST

### Non Patent Literature

[NPL 1] DOI=10.3389/conf.FBIOE.2016.01.01021
[NPL 2] R. Takahashi, et al. ACS Appl. Mater. Interfaces 2019, 11, 28267-28277

### SUMMARY OF THE INVENTION

### Technical Problem

However, in devices including a hybrid flow path in the related art, the hydrogel in a thin film part of the hybrid flow path is mechanically fragile. Therefore, for example, there is a problem that, when a tubular structure such as a tube for feeding a liquid is attached to the hybrid flow path, processing is difficult.

Therefore, there is a demand for a device including a hybrid flow path having wide ranges of selection for the shape of the flow path and selection of the base component and sufficient strength during processing while maintaining simplicity of a hybrid flow path forming process.

An object of the present invention is to provide a hydrogel fluid device which includes a flow path having an arbitrary shape that can be formed by a simple method and in which a material of a base component can be arbitrarily selected and the mechanical strength is excellent when the flow path is processed, and a method of producing the same.

### Means For Solving the Problem

An aspect of the present invention is a hydrogel fluid device including a base component; a film hydrogel that is provided in the base component and has an adhesive area that adheres to the base component and a non-adhesive area that does not adhere to the base component; a flow path that is formed at an interface between the hydrogel and the base component when a first polymer material in the non-adhesive area is separated from the base component due to swelling of the first polymer material constituting the hydrogel; and a bulk gel that covers one surface of the hydrogel outside the flow path and is composed of a second polymer material having a lower degree of swelling than the first polymer material.

### Effects of the Invention

According to the present invention, it is possible to provide a hydrogel fluid device which includes a flow path having an arbitrary shape that can be formed by a simple method and in which a material of a base component can be arbitrarily selected and the mechanical strength is excellent when the flow path is processed, and a method of producing the same.

### BRIEF DESCRIPTION OF DRAWINGS

FIG. 1 is a perspective view showing a hydrogel fluid device according to one embodiment.

FIG. 2 is a cross-sectional view of the hydrogel fluid device in FIG. 1 taken along the line II-II.

FIG. 3 is a cross-sectional view illustrating a method of producing a hydrogel fluid device according to one embodiment.

FIG. 4 is a cross-sectional view illustrating a method of producing a hydrogel fluid device according to one embodiment.

FIG. 5 is a cross-sectional view illustrating a method of producing a hydrogel fluid device according to one embodiment.

FIG. 6 is a cross-sectional view illustrating a method of producing a hydrogel fluid device according to one embodiment.

FIG. 7 is a cross-sectional view illustrating a method of producing a hydrogel fluid device according to one embodiment.

FIG. 8 is a cross-sectional view illustrating a method of producing a hydrogel fluid device according to one embodiment.

FIG. 9 is a cross-sectional view illustrating a method of producing a hydrogel fluid device according to one embodiment.

FIG. 10 is a cross-sectional view illustrating a method of producing a hydrogel fluid device according to one embodiment.

FIG. 11 is a cross-sectional view illustrating a method of producing a hydrogel fluid device according to one embodiment.

FIG. 12 is a cross-sectional view illustrating a method of producing a hydrogel fluid device according to one embodiment.

FIG. 13 is a cross-sectional view illustrating a method of producing a hydrogel fluid device according to one embodiment.

FIG. 14 is a cross-sectional view illustrating a method of producing a hydrogel fluid device according to one embodiment.

FIG. 15 is a cross-sectional view illustrating a method of producing a hydrogel fluid device according to one embodiment.

FIG. 16 is a cross-sectional view illustrating a method of producing a hydrogel fluid device according to one embodiment.

FIG. 17 is a cross-sectional view illustrating a method of producing a hydrogel fluid device according to one embodiment.

FIG. 18 is a cross-sectional view illustrating a method of producing a hydrogel fluid device according to one embodiment.

FIG. 19 is a cross-sectional view illustrating a method of producing a hydrogel fluid device according to one embodiment.

FIG. 20 is a cross-sectional view illustrating a method of producing a hydrogel fluid device according to one embodiment.

FIG. 21 is a cross-sectional view illustrating a method of producing a hydrogel fluid device according to one embodiment.

FIG. 22 is a cross-sectional view illustrating a method of producing a hydrogel fluid device according to one embodiment.

FIG. 23 is a cross-sectional view illustrating a method of producing a hydrogel fluid device according to one embodiment.

FIG. 24 shows images of a hydrogel fluid device of Example 1.

FIG. 25 shows cross-sectional fluorescence observation images of the hydrogel fluid device of Example 1.

FIG. 26 shows images showing a change when a fluorescent pigment liquid passes through a flow path of the hydrogel fluid device of Example 1.

FIG. 27 shows cross-sectional fluorescence observation images showing a change when a fluorescent pigment liquid passes through a flow path of the hydrogel fluid device of Example 1.

FIG. 28 is a perspective view illustrating a conventional device including a hybrid flow path.

FIG. 29 is a cross-sectional view of the hydrogel fluid device of FIG. 28 taken along the line IXXX-IXXX.

### DESCRIPTION OF EMBODIMENTS

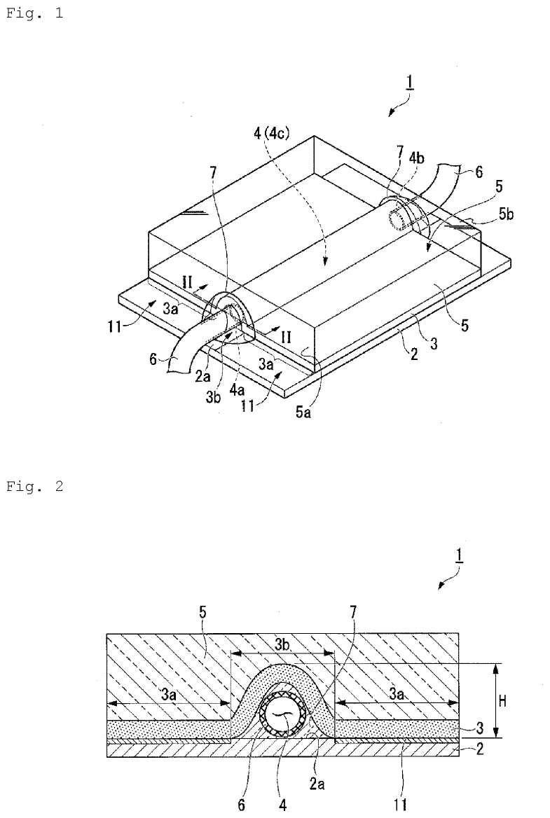

Hereinafter, preferable embodiments will be described with reference to FIG. 1 to FIG. 23, but the present invention is not limited to embodiments to be described below. In the drawings used in the following description, in order to facilitate understanding of features of the present invention, feature parts are enlarged for convenience of illustration in some cases, and dimensional proportions and the like of components are not necessarily the same as those of actual components.

<Hydrogel Fluid Device>

FIG. 1 is a perspective view of a hydrogel fluid device 1 according to one embodiment. FIG. 2 is an arrow cross-sectional view taken along the line segment II-II in the hydrogel fluid device 1. As shown in FIGS. 1 and 2, the hydrogel fluid device 1 includes a base component 2, a film hydrogel 3, a flow path 4, a bulk gel 5, and a tubular structure 6.

(Base Component)

The base component 2 supports the film hydrogel 3. The shape of the base component 2 is not particularly limited. The shape of the base component 2 maybe processed into a three-dimensional shape that can receive a more complicated external stimulus by a microfabrication technique or the like. The mechanical properties of the base component 2 are not limited. The rigidity of the base component 2 is different from the rigidity of the film hydrogel 3. For example, in one embodiment, the rigidity of the base component 2 is higher than the rigidity of the film hydrogel 3.

When the rigidity of the base component 2 is significantly higher than the rigidity of the film hydrogel 3, the film hydrogel 3 can simply be greatly deformed to induce a large space in a non-adhesive area 3b with respect to the base component 2. Therefore, the degree of freedom in forming the flow path 4, that is, the hybrid flow path, due to swelling of the film hydrogel 3, is improved.

In this specification, “swelling” means that a liquid such as water flows into a mesh structure of a gel and the volume of the gel increases.

The type of the substance of the base component 2 is not particularly limited. The base component 2 may or may not have light transmittance. Examples of materials of the base component 2 include glass having excellent translucency and chemical stability; elastomers such as polysilicone and synthetic rubber that can induce large deformation due to a mechanical stimulus; films containing carbon nanotubes, gold nanostructures, porphyrin derivatives, polydopamine, and indocyanine green that can induce a thermal stimulus due to a light stimulus; conductors that can induce a thermal stimulus due to an electrical stimulus; magnetic metal components that can induce a thermal stimulus due to a magnetic field stimulus; piezoelectric elements that can induce an electrical stimulus due to a mechanical stimulus; and light emitting diodes that can induce a light stimulus due to an electrical stimulus. The base component 2 may be another hydrogel having a different degree of swelling from the film hydrogel 3.

The material of the base component 2 is not limited to these examples. The base component 2 can be selected from among various materials and substances.

(Film Hydrogel)

The film hydrogel 3 is provided on one surface 2a of the base component 2. The film hydrogel 3 has an adhesive area 3a that adheres to the base component 2 and the non-adhesive area 3b that does not adhere to the base component 2. In the adhesive area 3a, the film hydrogel 3 and the base component 2 are adhered by a layer 11 of an adhesive functional group.

As shown in FIGS. 1 and 2, the non-adhesive area 3b is arranged in a band shape inside the flow path 4. Then, the adhesive area 3a is arranged on both sides of the non-adhesive area 3b in the extension direction. Here, the pattern of the adhesive area 3a and the non-adhesive area 3b shown in FIGS. 1 and 2 is an example, and various pattern shapes can be used according to the design.

In the hydrogel fluid device 1, the film hydrogel 3 is a hydrogel after the first polymer material constituting the hydrogel is swollen. That is, the film hydrogel 3 is a swollen hydrogel in which a liquid such as water flows into a mesh structure of the first polymer material or the like. Therefore, it can be said that the film hydrogel 3 is a swollen product of the first polymer material. The degree of swelling of the first polymer material is not particularly limited as long as it is relatively higher than that of a second polymer material to be described below and can form a desired flow path when the volume increases during swelling.

The first polymer material may be a chemically crosslinked gel obtained by chemical crosslinking or a physically crosslinked gel obtained by physical crosslinking. Examples of first polymer materials include synthetic water-soluble polymers such as polyacrylamide and polyvinyl alcohol; polysaccharides such as chitosan, alginic acid, and cellulose; and proteins such as collagen and albumin.

A method of synthesizing a first polymer material is not particularly limited. For example, in the case of an acrylic polymer, a gelation reaction due to chemical crosslinking according to a polymerization reaction of an acrylic group maybe exemplified. In the case of polysaccharides and proteins, gelation by physical bonding may be used or a chemical cross-linking agent typified by glutaraldehyde may be used. An example of the method of synthesizing a first polymer material will be described in detail in the section <Method of producing a hydrogel fluid device> below. As an example of the film hydrogel 3, for example, a hydrogel after a first polymer material 31 to be described below has swollen may be exemplified.

The type of the first polymer material is not particularly limited as long as it is a polymer material constituting a hydrogel. For example, when an external stimulus-responsive hydrogel is used as the first polymer material, it is possible to control shape deformation of the hydrogel fluid device 1.

In this specification, “external stimulus-responsiveness” is a property that the molecular structure of a polymer material changes in response to an external stimulus such as heat, light, electricity, and pH.

Examples of external stimulus-responsive hydrogels include heat-responsive hydrogels, pH-responsive hydrogels, and photoresponsive hydrogels.

Examples of heat-responsive hydrogels include gels containing poly(N-isopropylacrylamide), poly(methyl vinyl ether), and the like.

Examples of pH-responsive hydrogels include gels containing a polymer electrolyte synthesized from anionic or cationic monomers.

Examples of photoresponsive hydrogels include gels containing a polymer having spiropyran or azobenzene in a framework.

In addition, as the hydrogel, a tough hydrogel such as a double network gel, a slide ring gel, a Tetra-PEG gel, or a nano clay gel may be used. Here, “PEG” is an abbreviation for polyethylene glycol.

These hydrogels may be used alone or a plurality thereof may be used in combination. For example, a hydrogel that responds to a plurality of stimuli may be obtained by mixing a plurality of these hydrogels.

The first polymer material constituting the film hydrogel 3 may further contain various additives. The additive is not particularly limited as long as it does not inhibit formation of a hydrogel. An arbitrary function can be imparted to the hydrogel 3 using an arbitrary additive.

Examples of additives in the hydrogel 3 include biomolecules that improve biocompatibility; silver nanoparticles and surfactants for exhibiting antibacterial properties; ionic liquids for and conductive polymers increasing conductivity; magnetic nanoparticles for reacting in a magnetic field. However, the additive is not limited to these examples.

The thickness of the film hydrogel 3 is not particularly limited, but it is preferably a thickness at which the structural strength is maintained so that it is not crushed by its own weight. By increasing the degree of crosslinking of chemical crosslinking, the degree of crosslinking of physical crosslinking or the concentration of the polymer in the gel in order to maintain a strength sufficient to support its own weight while the thickness of the film hydrogel 3 is maintained to be thin, the mechanical properties of the hydrogel 3 may be improved.

The shape of the first polymer material constituting the hydrogel 3 does not have to be entirely film-like. That is, the first polymer material may have a part having a shape other than a film shape. The shape other than the film shape is not particularly limited, and various shapes can be selected according to the usage form. For example, in addition to a film shape, a plate shape and a block shape may be exemplified.

On the other hand, when it is desired to induce a channel-like shape deformation, a film shape is preferable because large deformation can be performed with a relatively small force.

(Flow Path)

The flow path 4 is formed at the interface between the base component 2 and the film hydrogel 3. The flow path 4 is formed when the first polymer material of the non-adhesive area 3b is separated from the base component 2 due to swelling of the first polymer material constituting the hydrogel 3.

Specifically, at the interface between the base component 2 and the film hydrogel 3, the position of the part where the first polymer material is separated from the base component 2 is controlled according to pattern arrangement between the adhesive area 3a and the non-adhesive area 3b. When the first polymer material swells and the first polymer material of the non-adhesive area 3b is selectively separated from the base component 2, buckling distortion of the first polymer material occurs and the film hydrogel 3 is formed.

As a result, a hybrid flow path, that is, the flow path 4, is formed as a space surrounded by the base component 2 and the film hydrogel 3.

The flow path 4 has the film hydrogel 3 at a part separated from the base component 2 as a flow path surface 4c. The flow path 4 has a first opening surface 4a and a second opening surface 4b. The flow path surface c of the flow path 4 is formed in a band shape between the first opening surface 4a and the second opening surface 4b in the extension direction of the non-adhesive area 3b. Then, the flow path 4 formed at the interface between the base component 2 and the film hydrogel 3 penetrates from the side of a first surface 5a to the side of a second surface 5b of the bulk gel 5.

(Bulk Gel)

In the hydrogel fluid device 1, the bulk gel 5 is a gel after the second polymer material constituting a gel has swollen. That is, the bulk gel 5 is a swollen gel in which a liquid such as water flows into a mesh structure of the second polymer material or the like. Therefore, it can be said that the film hydrogel 3 is a swollen product of the second polymer material.

The second polymer material has a lower degree of swelling than the first polymer material constituting the film hydrogel 3. The degree of swelling of the second polymer material is not particularly limited as long as it is lower than the degree of swelling of the first polymer material. For example, the degree of swelling of the second polymer material is preferably about 0.8 times to 1.2 times the degree of swelling in one direction based on the size before swelling.

Here, the “degree of swelling” can be calculated using the following Formula (1) after a treatment to be described below is performed. In the treatment, for example, the first polymer material or the second polymer material immediately after polymerization is cut out as a sample having a disk shape with an appropriate diameter, and the sample having a disk shape is left in pure water until no size change occurs.

(Degree of swelling)=d/d₀ Formula (1)

Here, in Formula (1), d is the diameter of the largest part of the sample after it is left in pure water, and d₀ is the diameter of the sample having a disk shape before it is left in pure water.

The second polymer material constituting the bulk gel 5 may be a hydrogel or a gel other than a hydrogel. When the second polymer material is a hydrogel, the second polymer material may be the same as or different from the first polymer material described in the above section (Film hydrogel). Specific examples of second polymer materials include a chemically crosslinked gel that is crosslinked by covalent bonds due to a radical polymerization reaction of monomers.

Examples of chemically crosslinked gels include polyacrylamide and its derivatives (polydimethylacrylamide, poly(N-isopropylacrylamide), etc.). In this case, when methylenebisacrylamide is used as a cross-linking agent, the crosslinking density may increase and the degree of swelling of the second polymer material may be within the above numerical range.

Examples of second polymer materials also include a physically crosslinked gel in which a polymer having a positive charge or negative charge and ions having a polyvalent charge opposite thereto are combined.

Examples of physically crosslinked gels include a physically crosslinked gel obtained by combining a sodium alginate solution, which is a polymer having a negative charge, and a calcium solution such as calcium chloride and calcium sulfate, and gelling them. In addition, a physically crosslinked gel obtained by combining poly(2,2′-disulfo-4,4′-bensidine terephthalamide: PBDT), which is a water-soluble polyaramide, and various multivalent metal cations (Ca²⁺, Fe²⁺, Al³⁺, Zr⁴⁺, Ti⁴⁺, etc.) may be exemplified. Instead of PBDT, TEMPO-oxidized cellulose nanofibers (NIPPON PAPER INDUSTRIES CO., LTD.), which are also negatively charged, and cellulose nanofibers (Oji Holdings Corporation) that are defibrated by a phosphoric acid esterification method may be used.

Here, “TEMPO” is an abbreviation for

1-oxyl(2,2,6,6-tetramethylpiperidine-1-oxyl radical).

The bulk gel 5 covers one surface of the film hydrogel 3 outside the flow path 4. In the hydrogel fluid device 1, the bulk gel 5 covers the surface of the film hydrogel 3 that is not in contact with the base component 2. That is, one surface of the film hydrogel 3 covered with the bulk gel 5 is one surface on the side opposite to (that is, facing the surface in contact with the base component 2) the surface in contact with the base component 2.

The bulk gel 5 covers the outside of the flow path 4. Therefore, when an aqueous liquid is poured into the flow path 4, the aqueous liquid permeates into the hydrogel on the flow path surface 4c, diffuses to the outside of the flow path 4 and reaches the gel 5.

For example, when the gel 5 is composed of a hydrogel, the aqueous liquid that has reached the gel 5 can diffuse inside the gel 5. Therefore, when an arbitrary object (for example, cells, cultured tissues) is disposed inside the gel 5 in advance, the aqueous liquid can be selectively supplied to the object in a predetermined area inside the gel 5.

For example, when a hydrogel having a positive charge or negative charge is used as the second polymer material constituting the gel 5, a function of preventing diffusion of small molecules having a specific charge can be imparted to the flow path 4. That is, a function of preventing small molecules having a specific charge from diffusing from the inside to the outside of the flow path 4 can be imparted to the gel 5.

In addition, for example, as the second polymer material constituting the gel 5, a hydrogel that switches between hydrophilic and hydrophobic properties in response to an external stimulus; and a hydrogel that can change the degree of swelling in response to an external stimulus can be used.

When a hydrogel that switches between hydrophilic and hydrophobic properties in response to an external stimulus is used, if the gel 5 is hydrophilic as a result of a response to an external stimulus, small molecules that diffuse into the gel 5 can be selectively limited to hydrophilic molecules. On the other hand, if the gel 5 is hydrophobic as a result of response to an external stimulus, small molecules that diffuse into the gel 5 can be selectively limited to hydrophobic molecules.

As in this example, according to the hydrogel fluid device 1, according to the selection of properties of the gel 5, it is possible to filter diffusion of small molecules that diffuse from the inside to the outside of the flow path 4. Since this filtering function can be changed in response to an external stimulus as in the above example, control over time is possible.

When a hydrogel in which the swelling rate can change (water content) in response to an external stimulus is used, if the swelling rate of the gel 5 is made relatively high as a result of response to an external stimulus, the diffusion rate of small molecules that diffuse into the gel 5 is relatively low. On the other hand, if the swelling rate of the gel 5 is made relatively low as a result of response to an external stimulus, the diffusion rate of small molecules that diffuse into the gel 5 is relatively high.

As in this example, according to the hydrogel fluid device 1, according to the selection of properties of the gel 5, the diffusion rate of small molecules that diffuse into the bulk gel 5 can be controlled. The function of controlling the diffusion rate can be changed in response to an external stimulus as in the above example. Therefore, it is possible to control the diffusion rate over time.

In addition, the bulk gel 5 may have a functional group that exhibits a predetermined response such as fluorescence to small molecules that have diffused from the flow path 4. In this case, when small molecules diffuse into the gel 5, since the gel 5 exhibits a predetermined response such as fluorescence, a function as a sensor for the diffused small molecules can be imparted to the hydrogel fluid device 1.

The mechanical strength of the bulk gel 5 is not particularly limited. For example, when the bulk gel 5 is required to have a modulus of elasticity (to 1.3 MPa) similar to that of polydimethylsiloxane (PDMS), the second polymer material is preferably a double network gel in which a physically crosslinked gel and a chemically crosslinked gel are combined. Since the double network gel has a tough double network structure, the mechanical strength is further improved.

The shape of the bulk gel 5 is not particularly limited.

However, the thickness of the bulk gel 5 needs to be larger than the height H of the flow path 4 in order to cover the flow path 4. The thickness of the bulk gel 5 may be further increased in order to provide sufficient strength to a bonding part of a tube.

The second polymer material constituting the bulk gel 5 may contain various additives as long as the degree of swelling does not change extremely. When an arbitrary additive is used, an arbitrary function can be imparted to the gel 5.

The additive in the gel 5 is not particularly limited as long as it does not inhibit gel formation. Examples thereof include biomolecules that improve biocompatibility; silver nanoparticles and surfactants for exhibiting antibacterial properties; ionic liquids and conductive polymers for increasing conductivity; magnetic nanoparticles for reacting in a magnetic field; and proteins that bind to glucose and enhance the fluorescence intensity.

The method of synthesizing a second polymer material is not particularly limited as long as it is a method that results in a lower degree of swelling than that of the first polymer material. An example of the method of synthesizing a second polymer material will be described in detail in the section <Method of producing a hydrogel fluid device> below. An example of the bulk gel 5 is, for example, a gel after a second polymer material 51 to be described below has swollen.

(Tubular Structure)

The tubular structures 6 and 6 are fixed to the first opening surface 4a and the second opening surface 4b of the flow path 4 with adhesives 7 and 7. Specifically, in the first opening surface 4a and the second opening surface 4b of the flow path 4, the tubular structures 6 and 6 are fixed between the base component 2 and the hydrogel 3 with the adhesives 7 and 7.

The tubular structure 6 is formed to supply an arbitrary fluid into the flow path 4.

The tubular structure 6 is, for example, a liquid feed tube. The liquid feed tube is not particularly limited as long as it is a portable tube that can feed in a liquid from the outside. The type of the liquid feed tube is not particularly limited. Examples of liquid feed tubes include tubes made of polytetrafluoroethylene (PTFE), tetrafluoroethylene (PFA), polyurethane, polyethylene, silicone, polyimide, and the like.

The outer diameter of the tubular structure 6 is not particularly limited. However, a tube having an outer diameter similar to the height H of the flow path 4 is desirable.

The adhesives 7 and 7 fix a liquid feed tube to the flow path 4. That is, the adhesives 7 and 7 fix the tubular structure 6 between the base component 2 and the film hydrogel 3.

As shown in FIG. 2, in the hydrogel fluid device 1, the adhesives 7 and 7 are densely filled into a space in contact with the flow path surface 4c of the flow path 4 around the tubular structure 6 on the opening surfaces 4a and 4b at the entrance of the flow path 4. It is desirable that the adhesives 7 and 7 have water resistance and adhesiveness to the base component 2 and the film hydrogel 3. Examples of the adhesives 7 and 7 include cyanoacrylate-based adhesives, silicone-based adhesives, and epoxy-based adhesives.

(Mechanism of Action)

The hydrogel fluid device 1 described above includes a bulk gel that covers one surface of a hydrogel outside the flow path and is composed of the second polymer material having a lower degree of swelling than the first polymer material constituting the hydrogel. Since the bulk gel composed of the second polymer material having a relatively low degree of swelling functions as an external framework of the film hydrogel, the structure of the film hydrogel can be toughened. In addition, the mesh structures in the gel penetrate into each other between the film hydrogel and the bulk gel, a structure in which the mesh structures are entangled can be constructed, and strong adhesion is realized.

Therefore, the thin film part of the flow path, which is conventionally mechanically fragile, is toughened by coating with a bulk gel. The structure of the toughened thin film part has sufficient strength to bond a tubular structure such as a liquid feed tube. Therefore, in the hydrogel fluid device 1, the mechanical strength is excellent when the flow path is processed.

In addition, the hydrogel fluid device 1 includes a flow path formed by separating the hydrogel in the non-adhesive area from the base component due to swelling of the first polymer material constituting the hydrogel. Therefore, the hydrogel fluid device and the flow path can be formed by a simple method. In addition, in the hydrogel fluid device 1, since a flow path is formed using free swelling of the first polymer material constituting the film hydrogel, the flow path 4 can have an arbitrary shape and structure.

In the hydrogel fluid device 1 described above, a producer can arbitrarily select the shape of the flow path. In addition, a base component, a film hydrogel, and bulk gel materials can be arbitrarily and independently selected. Therefore, according to a desired function to be realized by the hydrogel fluid device, various base components, film hydrogels, and bulk gels can be combined.

Therefore, according to the hydrogel fluid device 1, a fluid device having a wide range of functions and properties is provided.

In the hydrogel fluid device 1 described above, compared with a fluid device using a conventional hydrogel described in NPL 1, there is an advantage that the width of material selection and the width of the size scale of the flow path are wide. For example, a flow path having a complicated shape (a meandering shape, etc.) based on the mechanical instability of an elastic component can be easily produced.

In addition, unlike conventional PDMS-based fluid devices, since it has a bulk gel in which small water-soluble molecules can diffuse, it has an advantage that small water-soluble molecules can diffuse into the hydrogel fluid device.

(Application)

In the hydrogel fluid device 1 described above, since the mechanical strength is excellent when the flow path is processed, it has a toughness at which a tubular structure such as a liquid feed tube can bond thereto. In addition, the bulk gel 5 used as a reinforcing material for imparting toughness also allows permeability with respect to substances. Therefore, according to the hydrogel fluid device 1, a device in which the fluid can diffuse is provided. That is, in the hydrogel fluid device to which a liquid feed tube or the like is bonded, small molecules injected into the flow path via the liquid feed tube or the like can sequentially diffuse into the gel film hydrogel 3 and the bulk gel 5.

Producers can expect the hydrogel fluid device 1 described above to be used as a 3D cell culture substrate in which cell nutrients and differentiation factors and the like can diffuse in an arbitrary 3D direction from the flow path by using, for example, a bulk gel in which cells can be embedded.

Producers can expect the hydrogel fluid device 1 described above to be used as, for example, a cell culture substrate in which cells on a bulk gel are seeded, differentiation factors and the like diffuse from the flow path, and thus cell differentiation can be controlled.

For the hydrogel fluid device 1 described above, a functional group that exhibits a response such as fluorescence to small molecules that have diffused from the flow path can be introduced into the bulk gel. In this case, the hydrogel fluid device 1 can be applied to sensors that respond to specific small molecules.

In addition, when these functions of the gel 5 and functions of the film hydrogel are compounded, the hydrogel fluid device 1 having a more complicated function can be produced.

In this manner, the hydrogel fluid device can be applied to a wide range of applications such as a production system for culturing artificial tissues and a sensor for detecting a substance. For example, it may be a production system in which nutrients and various differentiation factors are supplied to a flow path, diffused to a bulk gel, and thus the substance is provided to cells, and artificial tissues are cultured. For example, it maybe a sensor that detects a substance diffused from a flow path by a stimulus response unit contained in a bulk gel.

<Method of Producing Hydrogel Fluid Device>

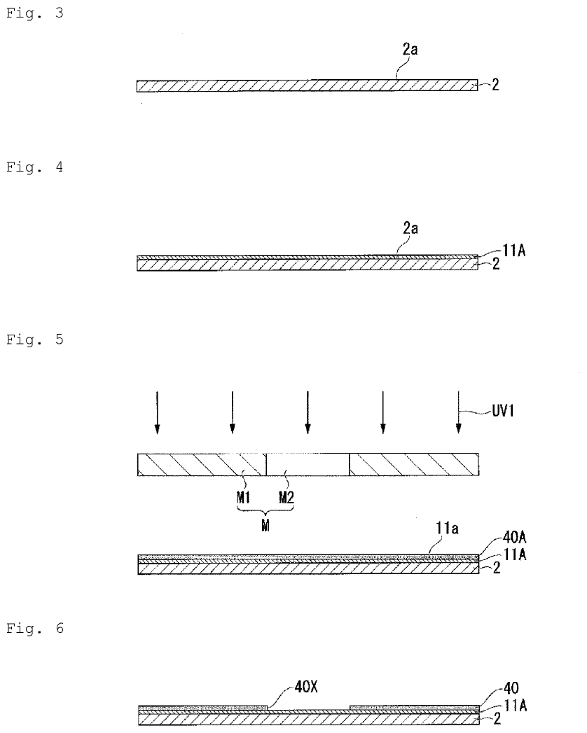

In an example of the method of producing a hydrogel fluid device of the present invention, as shown in FIG. 3 to FIG. 11, a layer 31A of the first polymer material 31 constituting the hydrogel is provided so that the adhesive area 3a that adheres to the base component 2, and the non-adhesive area 3b that does not adhere to the base component are formed on the one surface 2a of the base component 2.

Next, as shown in FIG. 12, when the first polymer material 31 is swollen, the first polymer material 31 in the non-adhesive area 3b is separated from the base component 2, and the flow path 4 is formed at the interface between the base component 2 and the layer of the first polymer material 31. Then, the first polymer material 31 is formed as the film hydrogel 3.

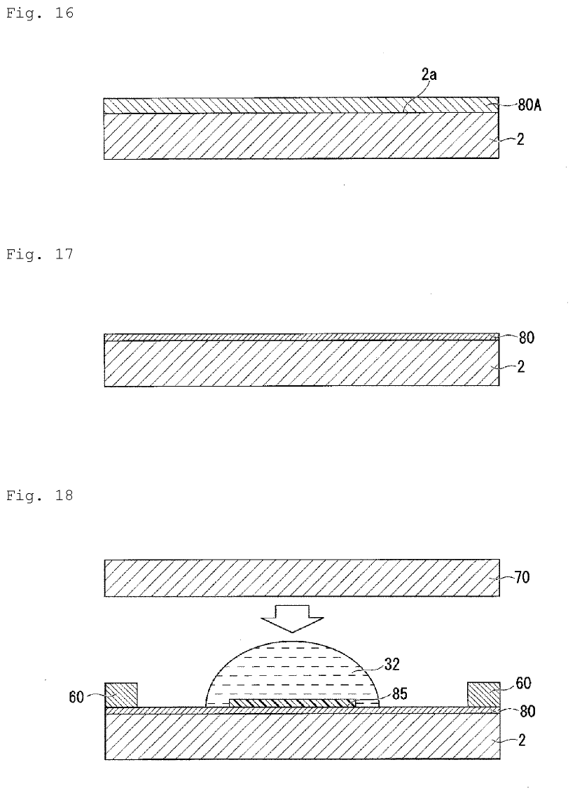

Next, as shown in FIGS. 13 and 14, the outside of the flow path 4 is covered with the bulk second polymer material 51 having a lower degree of swelling than the first polymer material 31, and the second polymer material 51 is then swollen to form the bulk gel 5.

Here, in this specification, the “first polymer material 31” means a film hydrogel before swelling, and is distinguished from the film hydrogel 3 after swelling. Similarly, the “bulk second polymer material 51” means a bulk gel before swelling, and is distinguished from the bulk gel 5 after swelling.

Hereinafter, methods of producing a hydrogel fluid device according to a first aspect, a second aspect, a third aspect, and a fourth aspect of the present invention will be described in order.

(First Aspect)

In the method of producing a hydrogel fluid device according to the first aspect, first, as shown in FIG. 3 to FIG. 8, a first pattern 11 of adhesive functional groups is formed on the one surface 2a of the base component 2. Specifically, as shown in FIG. 3 and FIG. 4, a layer 11A of adhesive functional groups is provided on the one surface 2a of the base component 2. According to the layer 11A, adhesive functional groups are presented on the one surface 2a of the base component 2.

Details and preferable forms of the base component 2 can be the same as those described in the above section <Hydrogel fluid device>. For example, as the base component 2, a glass substrate may be exemplified.

As the layer 11A of the adhesive functional group, for example, a layer of a silane coupling agent having an adhesive functional group may be exemplified.

In this specification, “adhesive functional group” means a functional group that can adhere to a first polymerizable monomer to be described below.

For example, when an acrylic monomer is used as a first polymerizable monomer, a (meth)acrylic group may be exemplified as the adhesive functional group. In this case, examples of silane coupling agents include

3-(methacryloyloxy) propyltrimethoxysilane.

A method of forming the layer 11A is not particularly limited. For example, the one surface 2a of the base component 2 is washed with a sodium hydroxide aqueous solution, 3-(methacryloyloxy) propyltrimethoxysilane is activated with oxygen plasma or piranha washing, a silane coupling agent is then applied to the one surface 2a of the base component 2, and thereby the layer 11A can be formed. Piranha washing commonly indicates a washing method using a mixed solution containing concentrated sulfuric acid and an aqueous hydrogen peroxide solution.

In the following description, a case in which the layer 11A is a monomolecular layer of a silane coupling agent will be described as an example, but the present invention is not limited to this example.

Next, as shown in FIG. 5, a resist layer 40A is additionally provided on one surface 11a of the layer 11A of the adhesive functional group. The resist layer 40A is not particularly limited. For example, it maybe a layer of a positive photoresist. In this case, the resist layer 40A can be formed by applying a positive photoresist on the surface of the layer 11A. A method of applying the positive photoresist is not particularly limited. For example, a spin coating method can be used.

Next, ultraviolet rays UV1 are emitted to the resist layer 40A through a mask M having a light-blocking part M1 and a light-transmissive part M2. The peak wavelength of ultraviolet rays UV1 is not particularly limited as long as it is within an absorption wavelength band range of the positive photoresist.

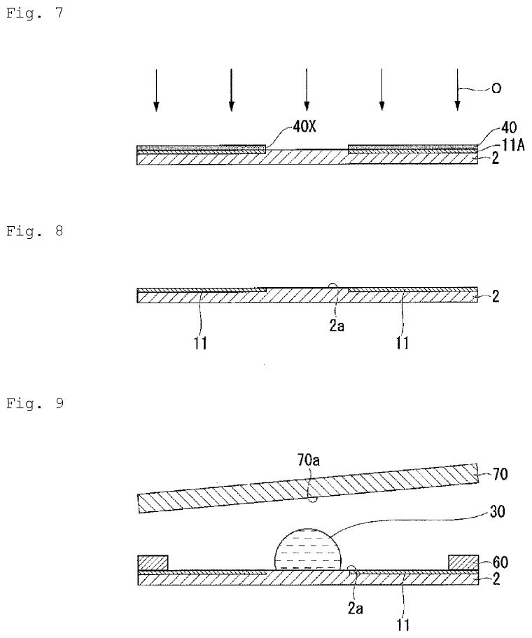

Next, as shown in FIG. 6, when ultraviolet rays UV1 are emitted and developing is then performed, apart of the resist layer 40A to which ultraviolet rays UV1 are emitted is removed, an opening part 40X is formed, and a pattern of a resist layer 40 is formed on one surface of the layer 11.

Next, as shown in FIG. 7, through the resist layer 40 in which the opening part 40X is formed, an oxygen plasma treatment using oxygen plasma O is performed on the layer 11A exposed by the opening part 40X. Thereby, the silane coupling agent of the layer 11A in the part exposed to the opening part 40X is removed.

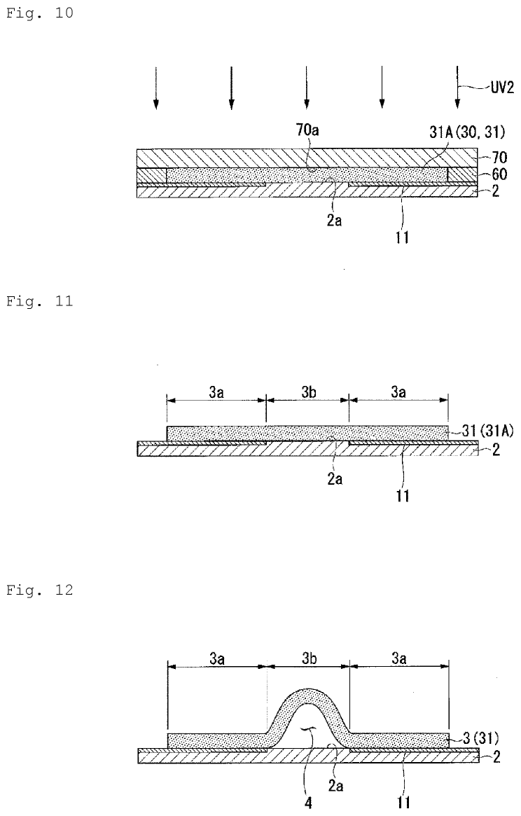

Next, as shown in FIG. 8, when the resist layer 40 is removed, the layer 11 of the silane coupling agent having a pattern shape is obtained (lift-off). The shape of the layer 11 can be appropriately adjusted by changing the shape of the light-transmissive part M2 in the mask M.

As in this example, after the adhesive functional group is present on the one surface 2a of the base component 2, when a photoresist is formed in an arbitrary pattern using a lithographic technique, the first pattern 11 of the adhesive functional group can be formed on the one surface 2a of the base component 2.

Next, as shown in FIG. 9, a first composition 30 containing first polymerizable monomers having a functional group that forms a chemical bond with adhesive functional groups is applied to the one surface 2a of the base component 2. Specifically, a spacer 60 is arranged on the one surface 2a on which the layer 11 is formed, and the first composition 30 containing first polymerizable monomers is added dropwise to the one surface 2a of the base component 2 in the area surrounded by the spacer 60. Then, a seal substrate 70 having ultraviolet ray transmission is covered so that the first composition 30 is covered. Thereby, the first composition 30 is spread over the area surrounded by the spacer 60, and the first composition 30 is applied to the one surface 2a of the base component 2.

As the seal substrate 70, for example, a glass substrate can be used. The surface of the seal substrate 70 that comes in contact with the first composition 30 may be washed by performing an oxygen plasma treatment.

One surface 70a of the seal substrate 70 may be, for example, a flat surface in order to keep the surface of the first polymer material 31 to be described below smooth, and may be processed into an arbitrary fine three-dimensional shape in order to transfer the arbitrary fine three-dimensional shape to the surface of the first polymer material 31 to be described below.

The first composition 30 contains first polymerizable monomers and a polymerization initiator, as necessary, an organic solvent and a polymerization accelerator.

The first polymerizable monomer is a monomer that can form a polymer by polymerization. Here, the first polymerizable monomer has a functional group that forms a chemical bond with adhesive functional groups. The first polymerizable monomer becomes the first polymer material 31 constituting the hydrogel by a polymerization reaction. It can be said that the first composition 30 applied to the base component is a precursor of the first polymer material 31.

The first polymerizable monomer is not particularly limited as long as it is a compound that can form a mesh structure of the first polymer material 31 by polymerization. Examples of first polymerizable monomers include an acrylic monomer having an acrylic group. However, the first polymerizable monomer is not limited to this example.

Examples of polymerization initiators include photopolymerization initiators and thermal polymerization initiators. A water-soluble polymerization initiator is preferable.

Examples of water-soluble photopolymerization initiators include 2-oxoglutaric acid,

4′-(2-hydroxyethoxy)-2-hydroxy-2-methylpropiophenone (Irgacure 2959), phenyl (2,4,6-trimethylbenzoyl) lithium phosphinate (LAP), and 2,2′-azobis[2-methyl-N-(2-hydroxyethyl)propionamide] (VA-086).

Examples of thermal polymerization initiators include ammonium peroxodisulfate (APS) and potassium peroxodisulfate (KPS).

Examples of organic solvents include dimethyl sulfoxide (DMSO), dimethylformamide (DMF), dimethylacetamide (DMA), and ethylene carbonate (EC).

Examples of polymerization accelerators include N,N,N′,N′-tetramethylethane-1,2-diamine (TEMED). When the polymerization accelerator is used, polymerization can be performed at room temperature within a few minutes.

When the polymerization accelerator such as TEMED is used, in order to prevent polymerization inhibition due to oxygen, glucose and glucose oxidase are used as deoxygenating agents or a polymerization reaction may be caused after sufficient degassing is performed in an inert gas atmosphere such as nitrogen or argon.

Next, as shown in FIG. 10, first polymerizable monomers are polymerized, the first composition 30 is gelled, and thus the first composition 30 is formed as the layer 31A of the first polymer material 31. During gelation, an appropriate stimulus suitable for the polymerization initiator is imparted to the first composition 30 to induce radical polymerization. Thereby, radical polymerization can start, and the layer of the first polymer material 31 can be provided on the one surface 2a of the base component 2.

In the following description, the method of producing a hydrogel fluid device according to the first aspect will be described using a case in which the first composition 30 contains a photopolymerization initiator as a polymerization initiator as an example, but the present invention is not limited to the following example.

As shown in FIG. 10, in the first aspect of the present invention, ultraviolet rays UV2 are emitted through the seal substrate 70. The peak wavelength of ultraviolet rays UV2 is not particularly limited as long as it is within an absorption wavelength band range of the photopolymerization initiator contained in the first composition 30. The peak wavelength of ultraviolet rays UV2 is, for example, 365 nm.

When ultraviolet rays UV2 are emitted, the first polymerizable monomer is polymerized, the first composition 30 is gelled, and thus the first composition 30 is formed as a film-like first polymer material 31.

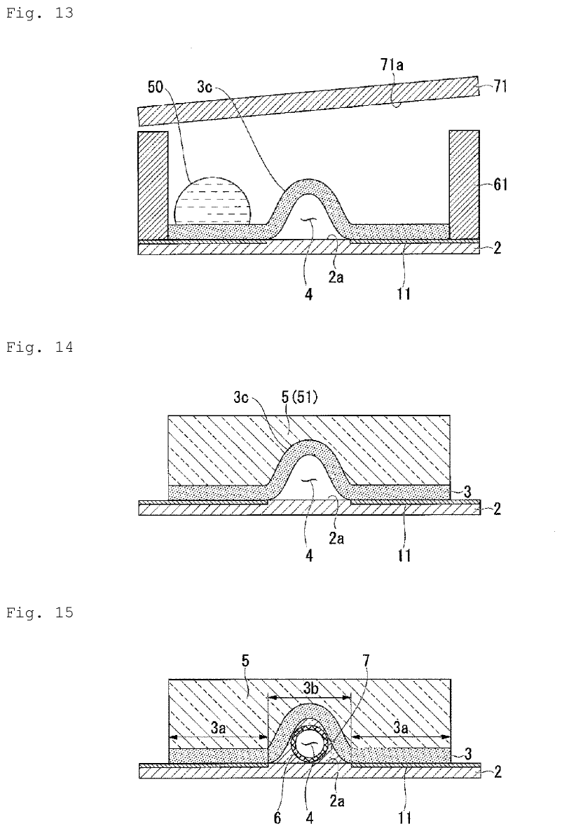

As shown in FIGS. 10 and 11, in the method of producing a hydrogel fluid device according to the first aspect, due to gelation of the first composition 30, the adhesive area 3a to which the base component 2 and the first polymer material 31 adhere and the non-adhesive area 3b to which the base component 2 and the hydrogel do not adhere are formed at the interface between the first polymer material 31 and the base component 2.

Specifically, when first polymerizable monomers are polymerized, the functional group of the first polymerizable monomer reacts with the adhesive functional group of the silane coupling agent in the layer 11 during the polymerization reaction. As a result, in a part in which the first composition 30 and the first pattern 11 (the layer 11) overlap, the first polymer material 31 after gelation adheres to the one surface 2a of the base component 2, and the adhesive area 3a is formed.

On the other hand, in a part of the base component 2 in which the first pattern 11 (the layer 11) is not formed, the first polymer material 31 does not adhere to the base component 2, and the non-adhesive area 3b is formed. In an area of the non-base component 2 in which the first pattern 11 (the layer 11) is not formed, first polymerizable monomers contained in the first composition 30 are polymerized.

As a result, as shown in FIG. 11, the layer 31A of the first polymer material 31 constituting the hydrogel can be provided so that the adhesive area 3a and the non-adhesive area 3b are formed.

The type of the polymerization reaction during gelation is not particularly limited. Generally, it is selected from the polymerization reaction according to the polymerization initiator in the first composition 30. Examples of polymerization reactions include radical polymerization using a polymerization initiator such as a photopolymerization initiator and a thermal polymerization initiator. For example, when the first polymerizable monomer is an acrylic monomer, chemical crosslinking by a polymerization reaction of an acrylic group may be exemplified.

Next, as shown in FIGS. 11 and 12, when the first polymer material 31 is swollen, the first polymer material 31 of the non-adhesive area 3b is separated from the base component 2, the flow path 4 is formed at the interface between the base component 2 and the layer 31A of the first polymer material, and the first polymer material 31 is formed as the film hydrogel 3.

A liquid used for swelling the first polymer material 31 is not particularly limited, and can be appropriately selected according to the polymer in the first polymer material 31. For example, an aqueous liquid such as water may be exemplified.

For example, when the layer 31A of the first polymer material 31 shown in FIG. 11 and the base component 2 are immersed in a large excess amount of pure water, water may be swollen in the first polymer material 31 and unreacted first polymerizable monomers may be removed from the first polymer material 31. Thereby, the film hydrogel 3 in which the first polymer material 31 is swollen with water is obtained.

Here, when the first polymer material 31 is swollen, in the layer 31A of the first polymer material 31, a part overlapping the layer 11 becomes the adhesive area 3a and a part not overlapping the layer 11 becomes the non-adhesive area 3b.

The layer 31A of the first polymer material 31 is not fixed to the base component 2 in the non-adhesive area 3b. Therefore, during volume increase due to swelling of the first polymer material 31, the volume of a part of the first polymer material 31 overlapping the non-adhesive area 3b in a plane can freely increase so that it is separated from the base component 2 in a direction intersecting the extension direction of the non-adhesive area 3b.

31A of the first polymer material 31 is fixed to the base component 2 in the adhesive area 3a. Therefore, the increase in volume of the part of the first polymer material 31 overlapping the adhesive area 3a in a plane in the direction intersecting the extension direction of the adhesive area 3a is regulated.

As a result, according to the degree of swelling of the first polymer material 31, the first polymer material 31 in the part overlapping the non-adhesive area 3b is deformed and separated from the base component 2, and the flow path 4 is formed. For example, as shown in FIG. 12, as a result of the shape of the first polymer material 31 that has changed due to swelling of the first polymer material 31, the first polymer material 31 is separated from the one surface 2a of the base component 2 and bent.

In the non-adhesive area 3b, since the first polymer material 31 swells largely and freely, in order to alleviate the increase in internal pressure due to the increase in volume, large bulging and deformation occur in a direction away from the base component 2. As a result, the first polymer material 31 is greatly separated from the side opposite to the base component 2, and the film hydrogel 3 in the non-adhesive area has a bucked and distorted shape. In this manner, the flow path 4, that is, the hybrid flow path, is formed in a space surrounded by the film hydrogel 3 and the base component 2.

The shape of the flow path 4 can be controlled by appropriately changing the pattern shape of the first pattern 11 and controlling the pattern shape of the adhesive area 3a and the non-adhesive area 3b. In addition, the shape of the flow path 4 can be controlled by adjusting, for example, the type of the first polymer material 31, the ratio between the rigidity of the base component 2 and the rigidity of the first polymer material 31, the thickness of the layer 31A of the first polymer material 31, and the like. The rigidity of the first polymer material 31 and the swelling rate of the first polymer material 31 can be controlled by changing the type of the first polymerizable monomer used in the first composition, the type and amount of the cross-linking agent, and the like.

The shape and thickness of the film hydrogel 3 can be controlled by adjusting the shape and thickness of the first polymer material 31 according to the size of the spacer 60, the shape of the spacer 60, and the like. Since the shape of the surface 70a (refer to FIGS. 9 and 10) facing the base component 2 of the seal substrate 70 is transferred to the film hydrogel 3, the shape of the film hydrogel 3 may be controlled by controlling the shape of the surface 70a.

The change between the first polymer material 31 and the film hydrogel 3 before and after swelling is a reversible change. Therefore, the shape of the flow path 4 can be controlled by changing the swelling rate of the film hydrogel 3. For example, the swelling rate of the hydrogel 3 can be changed by a method such as bringing water into contact with the hydrogel 3 to swell it or drying the hydrogel 3.

When the first polymer material 31 is an external stimulus-responsive hydrogel, the swelling rate of the first polymer material 31 is changed according to a stimulus input to the first polymer material 31, and the shape of the flow path 4 may be controlled.

Next, as shown in FIGS. 13 and 14, the outside of the flow path 4 is covered with the bulk second polymer material 51 having a lower degree of swelling than the first polymer material, and the second polymer material 51 is swollen to form the bulk gel 5. The liquid used for swelling the second polymer material 51 is not particularly limited, and can be appropriately selected depending on the polymer in the second polymer material 51. Examples thereof include aqueous liquids such as water and oily liquids such as benzene.

Specifically, for example, a spacer 61 is arranged on the one surface 2a on which the layer 11 is formed. Then, a low-swelling gel composition 50 containing low-swelling gel monomers is added dropwise to one surface 3c of the film hydrogel 3 outside the flow path 4 in the area surrounded by the spacer 61. Then, a seal substrate 71 having ultraviolet ray transmission is covered so that the low-swelling gel composition 50 is covered. Thereby, the low-swelling gel composition 50 is spread over the area surrounded by the spacer 61, and the low-swelling gel composition 50 is applied to the one surface 3c of the film hydrogel 3 outside the flow path 4.

As the seal substrate 71, for example, a glass substrate can be used. The surface of the seal substrate 71 that comes into contact with the low-swelling gel composition 50 may be washed by performing an oxygen plasma treatment.

One surface 71a of the seal substrate 71 may be, for example, a flat surface in order to keep the surface of the second polymer material 51 to be described below smooth, and may be processed into an arbitrary fine three-dimensional shape in order to transfer the arbitrary fine three-dimensional shape to the surface of the second polymer material 51 to be described below.

The low-swelling gel composition 50 contains, for example, a low-swelling gel monomer, and a polymerization initiator, as necessary, an organic solvent, a polymerization accelerator and a crosslinking polymer.

The low-swelling gel monomer is a monomer that can form a polymer by polymerization. The low-swelling gel monomer may be the same as or different from the first polymerizable monomer. The low-swelling gel monomer becomes a second polymer material constituting the bulk gel by a polymerization reaction. It can be said that the low-swelling gel composition 50 applied to the one surface 3c of the hydrogel 3 is a precursor of the bulk gel 5.

The low-swelling gel monomer is not particularly limited as long as it is a compound that can forma mesh structure of the second polymer material 51 by polymerization. Examples of low-swelling gel monomers include an acrylic monomer having an acrylic group. However, the low-swelling gel monomer is not limited to this example.

Examples of polymerization initiators in the low-swelling gel composition 50 include photopolymerization initiators and thermal polymerization initiators. A water-soluble polymerization initiator is preferable.

Examples of water-soluble photopolymerization initiators include 2-oxoglutaric acid,

4′-(2-hydroxyethoxy)-2-hydroxy-2-methylpropiophenone (Irgacure 2959), phenyl(2,4,6-trimethylbenzoyl) lithium phosphinate (LAP), and 2,2′-azobis[2-methyl-N-(2-hydroxyethyl)propionamide] (VA-086).

Examples of thermal polymerization initiators include ammonium peroxodisulfate (APS) and potassium peroxodisulfate (KPS).

It is possible to perform polymerization at room temperature within a few minutes by combining these thermal polymerization initiators and polymerization accelerators. Examples of polymerization accelerators include

N,N,N′,N′-tetramethylethane-1,2-diamine (TEMED).

Next, radical polymerization is induced by applying an appropriate stimulus according to the polymerization initiator in the low-swelling gel composition 50. Thereby, the low-swelling gel composition 50 is gelled by starting radical polymerization, and the one surface 3c of the film hydrogel 3 outside the flow path 4 is covered with the bulk second polymer material 51 having a low degree of swelling.

In this manner, by gelling the low-swelling gel composition 50 on the surface of the one surface 3c of the film hydrogel 3, the second polymer material 51 in which some polymers are infiltrated in the film hydrogel 3 can be obtained.

Next, the bulk second polymer material 51 is swollen to obtain the bulk gel 5. Since the bulk second polymer material 51 has a smaller degree of swelling than the first polymer material 31, it can function as an external framework that stabilizes the shape of the film hydrogel 3 and the flow path 4. Therefore, the chemical properties of the film hydrogel 3 can be changed while maintaining the function as the flow path without causing a change in the shape of the flow path 4 in which, generally, the shape also changes when the degree of swelling changes.

The type of the radical polymerization reaction in the bulk gel 5 is not particularly limited. Generally, it is selected from the polymerization reaction according to the polymerization initiator in the low-swelling gel composition 50.

Examples of polymerization reactions include radical polymerization using a polymerization initiator such as a photopolymerization initiator and a thermal polymerization initiator.

For example, when the bulk gel 5 is required to have a modulus of elasticity (to 1.3 MPa) similar to that of PDMS, the bulk gel 5 having a tough double network structure can be obtained by combining the above chemically crosslinked gel and physically crosslinked gel.

For example, a mixture containing acrylamide as a chemically crosslinked gel monomer, methylenebisacrylamide as a cross-linking agent, KPS as a polymerization initiator, and as necessary, TEMED as a polymerization accelerator, and (an aqueous solution containing) PBDT as a physically crosslinked gel polymer is added dropwise as the low-swelling gel composition 50 to the one surface 3c of the film hydrogel 3 outside the flow path 4, and thus the polyacrylamide gel is formed by radical polymerization. Then, by impregnating in the ZrCl₂O aqueous solution, the physically crosslinked gel is formed in the polyacrylamide gel according to PBDT and Zr⁴⁺ ions. In this case, even if the obtained hydrogel fluid device is immersed in pure water, the tough mechanical properties are not lost.

The shape and thickness of the bulk gel 5 can be controlled by adjusting the shape and thickness of the second polymer material 51 according to the size of the spacer 61, the shape of the spacer 61, and the like. Since the shape of the surface 71a (refer to FIG. 13) facing the film hydrogel 3 of the seal substrate 71 is transferred to the bulk gel 5, the shape of the bulk gel 5 may be controlled by controlling the shape of the surface 71a.

As the method of synthesizing a second polymer material constituting the bulk gel 5, a method of obtaining a physically crosslinked gel by combining a polymer having a positive charge or negative charge and ions having a polyvalent charge opposite thereto may be exemplified. In this case, first, the polymer solution is added dropwise to the one surface 3c of the hydrogel 3. Then, when multivalent ions are added dropwise and diffused, the second polymer material 51 in which some polymers are infiltrated in the film hydrogel 3 can be obtained.

As an example, a combination of a sodium alginate solution, which is a polymer having a negative charge, and a calcium solution such as calcium chloride or calcium sulfate may be exemplified.

In addition, poly(2,2′-disulfo-4,4′-bensidine terephthalamide: PBDT), which is a water-soluble polyaramide, is negatively charged, and combined with various multivalent metal cations (Ca²⁺, Fe²⁺, Al³⁺, Zr⁴⁺, Ti⁴⁺, etc.), and thus a low-swelling physically crosslinked gel can be obtained.

In addition, instead of PBDT, TEMPO-oxidized cellulose nanofibers (NIPPON PAPER INDUSTRIES CO., LTD.), which are also negatively charged, and cellulose nanofibers (Oji Holdings Corporation) that are defibrated by a phosphoric acid esterification method may be used.

As the second polymer material 51, agar containing carrageenan, gelatin composed of collagen, gelidium, and agar composed of gracilaria that gel according to the temperature may be used.

When agar containing carrageenan, gelatin composed of collagen, gelidium, or agar composed of gracilaria that gels according to the temperature is used, first, the low-swelling gel composition 50 that has fluidity when the temperature is raised is prepared, and the bulk second polymer material 51 in which some polymers are infiltrated in the film hydrogel 3 can be obtained.

As another method of covering the outside of the flow path 4 with the bulk second polymer material 51, a method of crosslinking polymers having a reactive side chain (for example, a polyvinyl alcohol, cellulose having a hydroxy group, etc.) with glutaraldehyde may be exemplified. In this case, first, the polymer solution is added dropwise to the outside of the flow path 4, and a cross-linking agent is then added dropwise and diffused. Thereby, the bulk second polymer material 51 in which some polymers are infiltrated in the film hydrogel 3 can be obtained.

In addition, in the method of producing a hydrogel fluid device according to the present embodiment, as shown in FIG. 15, the tubular structure 6 is bonded to an opening surface of the flow path 4 with the adhesive 7. Details of the tubular structure 6 and the adhesive 7 can be the same as those described in the above section <Hydrogel fluid device>.

Here, the time for bonding the tubular structure such as a liquid feed tube to the flow path is not particularly limited. That is, first, the flow path 4 is covered with the bulk gel 5, the mechanical properties are improved, the tubular structure 6 is then attached to the opening surface of the flow path 4, and may then be bonded with the adhesive 7, and the tubular structure 6 may be first bonded to the opening surface of the flow path 4 with the adhesive 7, and may then be covered with the bulk gel 5.

(Mechanism of Action)

In the method of producing a hydrogel fluid device described above, the outside of the flow path is covered with the bulk second polymer material having a lower degree of swelling than the first polymer material constituting the hydrogel, and the bulk second polymer material is then swollen.

Therefore, during gelation of the bulk gel, the mesh structures in the gel penetrate into each other between the bulk gel and the film hydrogel, and a structure in which the mesh structures are entangled can be constructed, and strong adhesion can be realized. That is, when the bulk gel before gelation infiltrates the hydrogel on the flow path surface, since a mesh structure invaginated between two gels is formed, and firmly adhered, the mechanical strength of the hydrogel on the flow path surface is improved. In addition, since the raw material of the bulk gel in a liquid state can be added dropwise to the surface outside the flow path and gelled, even if the shape of the flow path is complicated, the flow path can be covered with the bulk gel along the shape.

In addition, when the bulk gel swells, since the bulk gel has a lower degree of swelling than the film hydrogel, the bulk gel functions as an external framework that stabilizes the shape of the hydrogel on the flow path surface of the flow path. Therefore, a change in the shape of the hydrogel in the flow path in which, when the degree of swelling changes, the shape generally also changes is small, and chemical properties of the hydrogel can be changed while maintaining the function as the flow path.

As a result, the thin film part of the flow path, which is conventionally mechanically fragile, is toughened by coating with a bulk gel.

The structure of the toughened thin film part has sufficient strength to bond a tubular structure such as a liquid feed tube. Therefore, in the hydrogel fluid device 1, the mechanical strength is excellent when the flow path is processed.

In the method of producing a hydrogel fluid device described above, a layer of the first polymer material is provided so that the adhesive area and the non-adhesive area are formed on one surface of the base component, the first polymer material is swollen, and the first polymer material in the non-adhesive area is separated from the base component to form a flow path. Here, since the swelling of the first polymer material can be performed by, for example, an operation such as immersion in water or the like, the flow path can be easily formed.

In addition, the pattern arrangement of the adhesive area and the non-adhesive area can be arbitrarily determined, and a flow path is formed using free swelling of the film hydrogel. Therefore, a flow path having an arbitrary shape and structure can be formed.

In the method of producing a hydrogel fluid device described above, the shape of the flow path can be arbitrarily selected, and in addition, base component, hydrogel, and gel materials can be selected arbitrarily and independently. Therefore, according to a desired function to be realized by the hydrogel fluid device, various base components, hydrogels and gels can be combined. Therefore, according to the method of producing a hydrogel fluid device according to the present embodiment, it is possible to easily produce a fluid device having a wide range of functions and characteristics.

According to the method of producing a hydrogel fluid device described above, when a hybrid flow path formed of hydrogels of various chemical species is covered with the bulk gel, it is possible to produce a hydrogel fluid device that can diffuse small molecules into the gel according to liquid feeding from the outside.

In this manner, according to the method of producing a hydrogel fluid device, while maintaining an advantage that various chemical species of film hydrogels can be processed into a flow path shape by a simple method, it is possible to impart excellent mechanical strength and excellent functionality of the flow path enough for practical use to the hydrogel fluid device.

(Second Aspect)

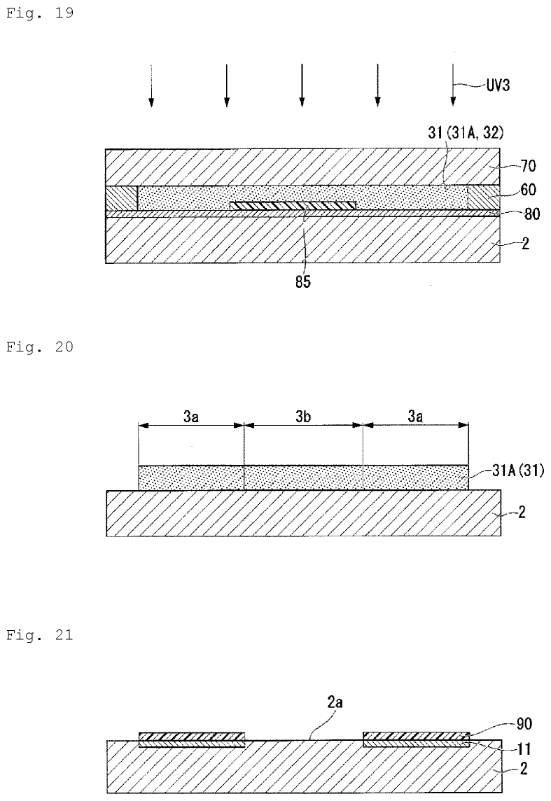

Hereinafter, the method of producing a hydrogel fluid device according to the second aspect will be described. In the method of producing a hydrogel fluid device according to the second aspect, first, as shown in FIGS. 16 and 17, when a layer of the first polymer material is provided on the one surface 2a of the base component 2, a layer 80 of the photopolymerization initiator is formed on the one surface 2a of the base component 2.

Specifically, as shown in FIG. 16, a coating film 80A of the photopolymerization initiator solution is formed on the one surface 2a of the base component 2. In the second aspect, as the base component 2, for example, it is preferable to use a resin substrate such as an elastomer or a polymer film that an organic solvent can infiltrate.

Examples of organic solvents that can infiltrate the resin substrate include polar solvents such as methanol, ethanol, and acetone.

In the method of producing a hydrogel fluid device according to the second aspect, a hydrogen abstraction type photopolymerization initiator is used as the photopolymerization initiator.

Examples of hydrogen abstraction type photopolymerization initiators include benzophenone, Michler's ketone, and Michler's ethyl ketone.

Examples of solvents for photopolymerization initiator solutions include polar solvents such as ethanol and acetone.

As shown in FIG. 17, the solvent is removed from the coating film 80A, and the layer 80 of the photopolymerization initiator is provided on the base component 2. In addition, since the polar solvent used in the photopolymerization initiator solution can infiltrate the resin substrate, a part of the photopolymerization initiator impregnates into the resin substrate as the solvent infiltrates into the resin substrate.

Next, as shown in FIG. 18, when the spacer 60 is arranged and a part of the layer 80 of the photopolymerization initiator is covered with a mask material 85, regarding a second composition 32 containing a second polymerizable monomer that forms a chemical bond with a polymerization initiator, the second composition 32 is added dropwise to the area surrounded by the spacer 60. Then, the seal substrate 70 having ultraviolet ray transmission is covered and the second composition 32 is spread over and applied to the area surrounded by the spacer 60.

The mask material 85 is arranged in a part of the film hydrogel in which the non-adhesive area 3b is desired to be formed. As the mask material 85, a material that does not react with the second polymerizable monomer is used. For example, a paraffin film can be used as the mask material 85.

The second composition 32 contains a second polymerizable monomer, a hydrogen abstraction type photopolymerization initiator, and as necessary, an organic solvent. However, when the concentration of the hydrogen abstraction type photopolymerization initiator contained in the layer 80 is sufficiently high, the second composition 32 may not contain a hydrogen abstraction type photopolymerization initiator. The “concentration is sufficiently high” means that, in the photopolymerization initiator solution used for forming the coating film 80A, for example, the concentration of the photopolymerization initiator is 10 mass % or more.

The second polymerizable monomer is a monomer that can form a polymer by polymerization. Here, the second polymerizable monomer has a functional group that forms a chemical bond with a polymerization initiator. The second polymerizable monomer becomes a first polymer material constituting the hydrogel by a polymerization reaction.

The second polymerizable monomer is not particularly limited as long as it is a compound that can form a mesh structure of the first polymer material 31 by polymerization. Examples of second polymerizable monomers include an acrylic monomer having an acrylic group. However, the second polymerizable monomer is not limited to this example.

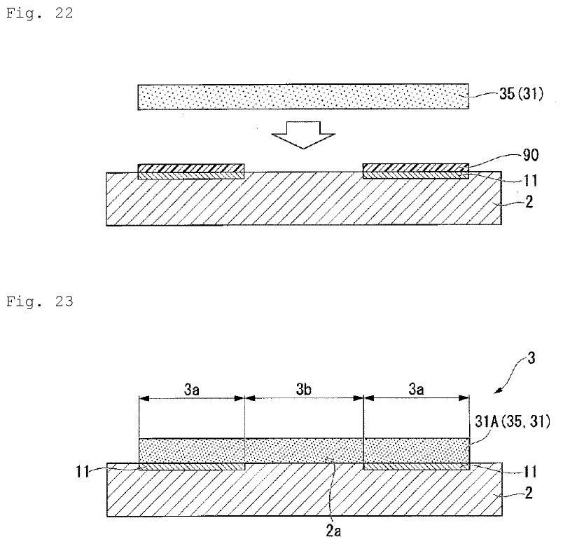

Next, as shown in FIGS. 19 and 20, when the second polymerizable monomer is polymerized and the second composition 32 is gelled, an adhesive area is formed in a part overlapping the layer 80 of the photopolymerization initiator, and the second composition 32 is formed as the first polymer material 31.

Specifically, as shown in FIG. 19, ultraviolet rays UV3 are emitted through the seal substrate 70. The peak wavelength of ultraviolet rays UV3 is included in the absorption wavelength band of the photopolymerization initiator contained in the layer 80. The peak wavelength of ultraviolet rays UV3 is, for example, 365 nm.

When ultraviolet rays UV3 are emitted, the photopolymerization initiator is reacted in a predetermined pattern. According to emission of ultraviolet rays UV3, in a part of the layer 80 not overlapping the mask material 85, that is, in a part in which the layer 80 overlaps the second composition 32, the photopolymerization initiator of the layer 80 abstracts hydrogen atoms from the base component 2 in the pattern of the mask material 85. Thereby, radicals, which are reaction starting points, are generated in the base component 2. The monomers contained in the second composition 32 are polymerized using radicals generated in the base component 2 as starting points and the first polymer material 31 is obtained. Therefore, the first polymer material 31 adheres to the base component 2 in a part overlapping the layer 80 of the photopolymerization initiator.

On the other hand, in a part of the layer 80 of the photopolymerization initiator overlapping the mask material 85, that is, in a part in which the layer 80 does not overlap the second composition 32, ultraviolet rays UV3 are blocked and hydrogen atom abstraction from the base component 2 with the photopolymerization initiator does not occur. Even if hydrogen atoms are abstracted from the base component 2 and radicals are generated, the second composition 32 is not in contact therewith. Therefore, the generated radicals do not react with the second polymerizable monomer in the second composition 32. Therefore, in a part of the layer 80 overlapping the mask material 85, second polymerizable monomers contained in the second composition 32 are polymerized without being bonded to the base component 2.

Next, as shown in FIG. 20, the seal substrate 70 is removed. In this manner, in the method of producing a hydrogel fluid device according to the second aspect, the layer 31A of the first polymer material 31 constituting the hydrogel is provided so that the adhesive area 3a that adheres to the base component 2 and the non-adhesive area 3b that does not adhere to the base component 2 are formed.

In the above example, by using the mask material 85, the polymerization initiator is reacted in a pattern to polymerize the monomers, but this aspect is not limited thereto.

For example, in the layer 80 shown in FIG. 17, when ultraviolet rays are selectively emitted to only a part in which the non-adhesive area is desired to be formed, the photopolymerization initiator in the part to which ultraviolet rays are emitted is excited, and hydrogen on the surface of the base component is abstracted and bonded to the surface of the base component. In this manner, a layer of the photopolymerization initiator in the part to which ultraviolet rays are emitted is provided in the base component in advance. This ultraviolet ray emission is referred to as “first ultraviolet ray emission”.

After the first ultraviolet ray emission, the surface of the base component is washed with a polar solvent contained in the photopolymerization initiator solution. Thereby, it is possible to remove the photopolymerization initiator in a part other than the layer of the photopolymerization initiator provided in the base component from the surface of the base component.

Next, when second ultraviolet ray emission is additionally performed on the base component that has been subjected to the first ultraviolet ray emission, the layer of the photopolymerization initiator that is provided on the surface of the base component by the first ultraviolet ray emission and remains in a predetermined pattern is reacted. Therefore, after the layer pattern of the photopolymerization initiator is formed by the first ultraviolet ray emission, the second composition is applied to the one surface of the base component, the second polymerizable monomers that have been subjected to the second ultraviolet ray emission are polymerized, and thus the photopolymerization initiator fixed to the surface of the base component react with the second polymerizable monomers, and the adhesive area 3a is formed in a part in which the layer of the photopolymerization initiator overlaps the second composition.

In this manner, the layer 31A of the first polymer material 31 constituting the hydrogel may be provided so that the adhesive area 3a that adheres to the base component 2 and the non-adhesive area 3b that does not adhere to the base component 2 are formed.

In addition, before the coating film 80A shown in FIG. 16 is formed, a film of a silane coupling agent having a water- and oil-repellent functional group may be selectively formed on the one surface 2a of the base component 2 in advance. The film of a silane coupling agent having a water- and oil-repellent functional group can be provided on one surface of the base component by, for example, lithography.

When the coating film 80A is formed on the base component 2 that has been subjected to such a treatment, the film of the silane coupling agent repels the photopolymerization initiator solution, and the coating film 80A of the photopolymerization initiator solution is formed in a pattern shape complementary to the film of the silane coupling agent. Examples of such a silane coupling agent include (trichloro (1H,1H,2H, 2H-heptadecafluorodecyl)silane.

Then, the layer 80 is formed from the coating film 80A formed in a pattern shape complementary to the film of the silane coupling agent, and the second composition is applied to one surface of the base component 2. When ultraviolet rays are emitted in this state, in a part of the pattern shape complementary to the film of the silane coupling agent, the second polymerizable monomers are polymerized and react with the layer 80 of the photopolymerization initiator. In this case, in the part in which the layer of the photopolymerization initiator overlaps the second composition, the second polymerizable monomers react with the photopolymerization initiator, and the adhesive area is formed.

On the other hand, in the part in which a silane coupling agent having a water- and oil-repellent functional group is present on one surface of the base component, since the hydrogen abstraction type initiator is not introduced on the water- and oil-repellent functional group, and there is no polymerization ability, the substrate and the first polymer material can be patterned and adhered.

In this manner, the layer 31A of the first polymer material constituting the hydrogel may be provided so that the adhesive area 3a that adheres to the base component 2 and the non-adhesive area 3b that does not adhere to the base component 2 are formed.

In the method of producing a hydrogel fluid device according to the second aspect, details and preferable forms of the following configurations (A), (B), (C), and (D) can be the same as those described in the above method of producing a hydrogel fluid device according to the first aspect.
Configuration (A) : A first polymer material is swollen, the first polymer material in a non-adhesive area is separated from a base component, a flow path is formed at an interface between the base component and the layer of the first polymer material, and the first polymer material is formed as a film hydrogel.
Configuration (B): The outside of the flow path is covered with a bulk second polymer material having a lower degree of swelling than the first polymer material.
Configuration (C): The second polymer material is swollen to form a bulk gel.
Configuration (D): Additionally, a tubular structure is bonded to an opening surface of the flow path with an adhesive.

The description of these overlapping configurations (A) , (B), (C), and (D) will be omitted.

Also in the method of producing a hydrogel fluid device according to the second aspect described above, the same mechanism of action as in the method of producing a hydrogel fluid device according to the first aspect is obtained.

(Third Aspect)

Hereinafter, the method of producing a hydrogel fluid device according to the third aspect will be described.

In the method of producing a hydrogel fluid device according to the third aspect, first, as shown in FIG. 21, when the layer of the first polymer material is provided on the one surface 2a of the base component 2, a second pattern of a layer 90 of a gel-embedding polymer is formed on the one surface 2a of the base component 2.

Specifically, as shown in FIG. 21, the layer 11 of the silane coupling agent having a pattern shape is formed on the one surface 2a of the base component 2. Details of the silane coupling agent and the pattern forming method can be the same as those described in the method of producing a hydrogel fluid device according to the first aspect.

Then, the layer 90 of the gel-embedding polymer is formed on the surface of the layer 11 and a pattern of the gel-embedding polymer is formed. Examples of gel-embedding polymers include chitosan, alginic acid, and polyvinyl alcohols.

In forming of the layer 90, a grafting to method or a grafting from method can be used. Thereby, the adhesive functional group of the silane coupling agent can react with the gel-embedding polymer.

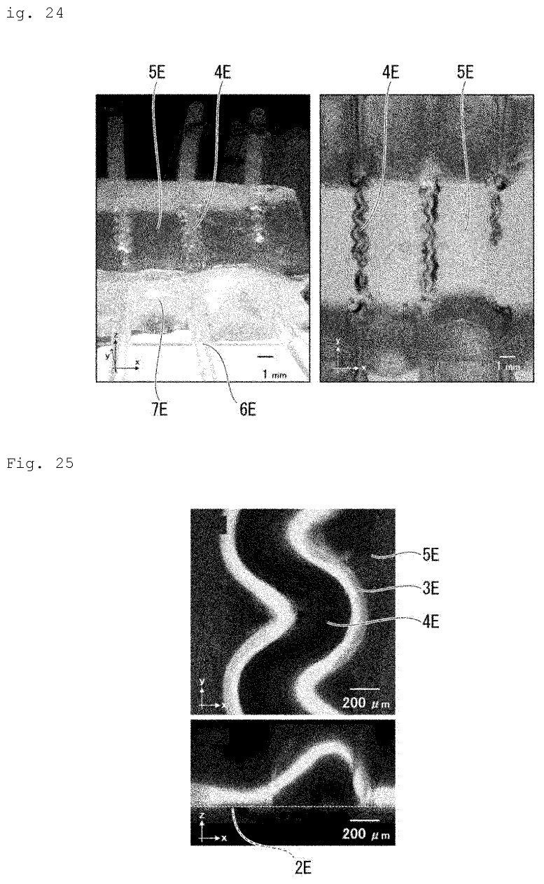

Next, as shown in FIGS. 22 and 23, a sheet material 35 having the first polymer material 31 as a forming material is arranged on the one surface 2a of the base component 2 on which the second pattern is formed so that the layer 90 formed in a pattern is covered.

Then, the sheet material 35 is brought into contact with the gel-embedding polymer. When the layer 90 and the sheet material 35 come into contact with each other, the gel-embedding polymer contained in the layer 90 permeates into the sheet material 35, and is entangled with the mesh structure of the first polymer material 31. Thereby, the gel-embedding polymer and the hydrogel are physically or chemically bonded, and the sheet material 35 and the base component 2 can be adhered to each other.

When the sheet material 35 is brought into contact with the layer 90, the pH of the first polymer material constituting the sheet material 35 may be changed, and a low-molecular-weight cross-linking agent typified by glutaraldehyde may be simultaneously diffused in the sheet material 35. Thereby, a physical bond or chemical bond between gel-embedding polymers is formed, and the gel-embedding polymer and the first polymer material can be more firmly adhered to each other.

The layer 31A of the first polymer material constituting the hydrogel may be provided so that the adhesive area and the non-adhesive area are formed in this manner. In FIG. 23, the part of the sheet material 35 overlapping the layer 90 becomes the adhesive area 3a, and the part of the sheet material 35 not overlapping the layer 90 becomes the non-adhesive area 3b.

In the method of producing a hydrogel fluid device according to the third aspect, details and preferable forms of the following configurations (A), (B), (C), and (D) can be the same as those described in the above method of producing a hydrogel fluid device according to the first aspect, as in the method of producing a hydrogel fluid device according to the second aspect.
Configuration (A): A first polymer material is swollen, the first polymer material in a non-adhesive area is separated from a base component, a flow path is formed at an interface between the base component and the layer of the first polymer material, and the first polymer material is formed as a film hydrogel.
Configuration (B): The outside of the flow path is covered with a bulk second polymer material having a lower degree of swelling than the first polymer material.
Configuration (C): The second polymer material is swollen to form a bulk gel.
Configuration (D): Additionally, a tubular structure is bonded to an opening surface of the flow path with an adhesive.

The description of these overlapping configurations (A) , (B), (C), and (D) will be omitted.

Also in the method of producing a hydrogel fluid device according to the third aspect described above, the same mechanism of action as in the method of producing a hydrogel fluid device according to the first aspect is obtained.

(Fourth Aspect)

Hereinafter, the method of producing a hydrogel fluid device according to the fourth aspect will be described. In the method of producing a hydrogel fluid device according to the fourth aspect, first, when a layer of the first polymer material is provided on one surface of the base component, a second pattern of a layer of adhesive molecules is formed on one surface of the base component.

Examples of adhesive molecules include a cyanoacrylate-based compound. The pattern of adhesive molecules can be formed by a lithographic technique. In this case, the size of the pattern of adhesive molecules depends on the resolution of the lithographic technique used.

The size of the pattern of adhesive molecules is not particularly limited within the scope of the lithographic technique. The lithography method is not particularly limited. For example, a method using a photomask, a method using a patterned UV light source, and micro-contact patterning (μCP) in which a pattern is formed with an elastic material such as PDMS in advance and a chemical substance is transferred in the manner of a stamp may be exemplified.

Next, a sheet material using the first polymer material as a forming material is arranged on one surface of the base component in which the second pattern of the layer of adhesive molecules is formed. Then, the sheet material is brought into contact with the adhesive molecules. When the layer of adhesive molecules and the sheet material come into contact with each other, adhesive molecules contained in the layer of adhesive molecules permeate into the sheet material and are entangled with the mesh structure of the first polymer material. As a result, when the adhesive molecules and the hydrogel are physically or chemically bonded, the sheet material and the base component can be adhered to each other.

The layer 31A of the first polymer material constituting the hydrogel may be provided so that the adhesive area and the non-adhesive area are formed in this manner. In this case, a part of the sheet material overlapping the layer of adhesive molecules becomes the adhesive area, and a part of the sheet material not overlapping the layer of adhesive molecules becomes the non-adhesive area.

In the method of producing a hydrogel fluid device according to the fourth aspect, details and preferable forms of the following configurations (A), (B), (C), and (D) can be the same as those described in the above method of producing a hydrogel fluid device according to the first aspect, as in the method of producing a hydrogel fluid device according to the second aspect.
Configuration (A): A first polymer material is swollen, the first polymer material in a non-adhesive area is separated from a base component, a flow path is formed at an interface between the base component and the layer of the first polymer material, and the first polymer material is formed as a film hydrogel.
Configuration (B): The outside of the flow path is covered with a bulk second polymer material having a lower degree of swelling than the first polymer material.
Configuration (C): The second polymer material is swollen to form a bulk gel.
Configuration (D): Additionally, a tubular structure is bonded to an opening surface of the flow path with an adhesive.

The description of these overlapping configurations (A) , (B), (C), and (D) will be omitted.

Also in the method of producing a hydrogel fluid device according to the fourth aspect described above, the same mechanism of action as in the method of producing a hydrogel fluid device according to the first aspect is obtained.

While some embodiments of the present invention have been described above with reference to the drawings, the present invention is not limited to the above embodiments and examples. Various shapes, combinations and the like of configurations shown in the above examples are only examples, and can be variously changed based on design requirements and the like without departing from the spirit and scope of the present invention. In addition, embodiments obtained by arbitrarily and appropriately combining technical methods disclosed in the above embodiments are also included in the technical scope of the present invention.

It can be said that, as a specific example of combinations, one aspect of the present invention relates to the following [1] to [8].
[1] A hydrogel fluid device, including: a base component; a film hydrogel that is provided in the base component and has an adhesive area that adheres to the base component and a non-adhesive area that does not adhere to the base component; a flow path that is formed at an interface between the hydrogel and the base component when a first polymer material in the non-adhesive area is separated from the base component due to swelling of the first polymer material constituting the hydrogel; and a bulk gel that covers one surface of the hydrogel outside the flow path and is composed of a second polymer material having a lower degree of swelling than the first polymer material.
[2] The hydrogel fluid device according to [1], wherein the non-adhesive area is arranged in a band shape inside the flow path, and wherein the adhesive area is arranged on both sides of the non-adhesive area in an extension direction.
[2] The hydrogel fluid device according to [1] or [2], further including a tubular structure fixed between the base component and the hydrogel with an adhesive.
[4] A method of producing a hydrogel fluid device, including: providing a layer of a first polymer material constituting a hydrogel so that an adhesive area that adheres to a base component and a non-adhesive area that does not adhere to the base component are formed on one surface of the base component; separating the first polymer material in the non-adhesive area from the base component by swelling the first polymer material, forming a flow path at an interface between the base component and the layer of the first polymer material, and forming the first polymer material as a film hydrogel; covering the outside of the flow path with a bulk second polymer material having a lower degree of swelling than the first polymer material; and swelling the second polymer material to form a bulk gel.
[5] The method of producing a hydrogel fluid device according to [4], wherein, when the layer of the first polymer material is provided on the one surface of the base component, a first pattern of adhesive functional groups is formed on the one surface of the base component, wherein a first composition containing first polymerizable monomers having a functional group that forms a chemical bond with the adhesive functional groups is applied to the one surface, and wherein the first polymerizable monomers are polymerized, the first composition is gelled, and thus the first composition is formed as the first polymer material.
[6] The method of producing a hydrogel fluid device according to [4], wherein, when the layer of the first polymer material is provided on the one surface of the base component, a layer of a polymerization initiator is formed on the one surface of the base component, wherein a second composition containing second polymerizable monomers that form a chemical bond with the polymerization initiator is applied to one surface of the layer of the polymerization initiator, and wherein, when the second polymerizable monomers are polymerized and the second composition is gelled, the adhesive area is formed in a part in which the layer of the polymerization initiator overlaps the second composition, and the second composition is formed as the first polymer material.
[7]The method of producing a hydrogel fluid device according to [4], wherein, when the layer of the first polymer material is provided on the one surface of the base component, a second pattern of gel-embedding polymers or adhesive molecules is formed on the one surface of the base component, wherein a sheet material using the first polymer material as a forming material is arranged on the one surface of the base component in which the second pattern is formed, and wherein the sheet material is brought into contact with the gel-embedding polymers or adhesive molecules.
[8]The method of producing a hydrogel fluid device according to anyone of [4] to [7], further including bonding a tubular structure to an opening surface of the flow path with an adhesive.

### EXAMPLES

Hereinafter, the present invention will be described in detail with reference to examples. However, the present invention is not limited to the following description.

First, a glass substrate was washed to obtain a washed glass substrate. The washed glass substrate was treated with oxygen plasma to obtain a surface-activated glass substrate. A silanized glass substrate was obtained using the surface-activated glass substrate and a radically reactive silane coupling agent. Next, a thin film of a positive photoresist was formed on the silanized glass substrate by spin coating. Then, strip-shaped pattern UV light having a line width of 1 mm was emitted and developing was performed to obtain a silanized glass substrate having no resist only in a strip-shaped part having a line width of 1 mm.

Then, the part without the resist was washed by treating with oxygen plasma, and the resist was lifted off with acetone to obtain a base component in which a first pattern of adhesive functional groups was formed in addition to the strip-shaped part (hereinafter referred to as a “patterned silanized substrate”).

Next, polyacrylamide gel was polymerized on the patterned silanized substrate. Then, a spacer was arranged at both ends on the patterned silanized substrate and the following gel precursor solution 1 was then added dropwise to the center of the patterned silanized substrate.

Gel Precursor Solution 1: a solution containing acrylamide as a first polymerizable monomer, fluorescein-o-acrylate as a fluorescent monomer, methylenebisacrylamide as a cross-linking agent, KPS as a thermal polymerization initiator, and TEMED as a polymerization accelerator.

Next, a cover glass treated with oxygen plasma (hereinafter referred to as a “seal substrate 1E”) was placed on the patterned silanized substrate coated with the gel precursor solution 1 from the top, and the gel precursor solution 1 was inserted between the patterned silanized glass substrate and the seal substrate 1E. Then, the gel precursor solution 1 was completely gelled by UV emission, and the gel precursor solution 1 was used as a first polymer material (that is, a hydrogel).

After gelation, the seal substrate 1E was removed, the first polymer material was swollen with water, unreacted gel precursor molecules were removed, and a hybrid flow path of Example 1 composed of a film hydrogel and a glass substrate was obtained.

In the hybrid flow path of Example 1, since the non-adhesive area was arranged in a strip shape having a line width of 1 mm, only the first polymer material in the area was selectively and freely swollen. As a result, only the first polymer material in the non-adhesive area significantly changed from a planar shape to a three-dimensional flow path shape.

Next, after a spacer was arranged at both ends of the substrate of the hybrid flow path of Example 1, the following gel precursor solution 2 was added dropwise to the hybrid flow path.

Gel Precursor Solution 2: a solution containing acrylamide as a low-swelling gel monomer, methylenebisacrylamide as a cross-linking agent, KPS as a thermal polymerization initiator, TEMED as a polymerization accelerator, and PBDT as a physical crosslinking polymer.

A cover glass treated with oxygen plasma (hereinafter referred to as a “seal substrate 2E”) was placed on the substrate in which the gel precursor solution 2 was added dropwise to the hybrid flow path from the top, and the gel precursor solution 2 was inserted between the hybrid flow path and the seal substrate 2E.

Next, the gel precursor solution 2 was completely gelled, and the precursor solution 2 was used as a bulk second polymer material. Then, after gelation, the seal substrate 2E was removed and immersed in a ZrCl₂O solution to form a physical crosslinking with PBDT and Zr⁴⁺ ions. Then, excess ions and the like were washed away to obtain a hydrogel fluid device having a base component, a film hydrogel, and a bulk gel 5.

In addition, a PTFE tube having an outer diameter of 1 mm was inserted into the hybrid flow path, and the glass substrate, the film hydrogel, and the PTFE tube were bonded using an adhesive to obtain a hydrogel fluid device of Example 1.

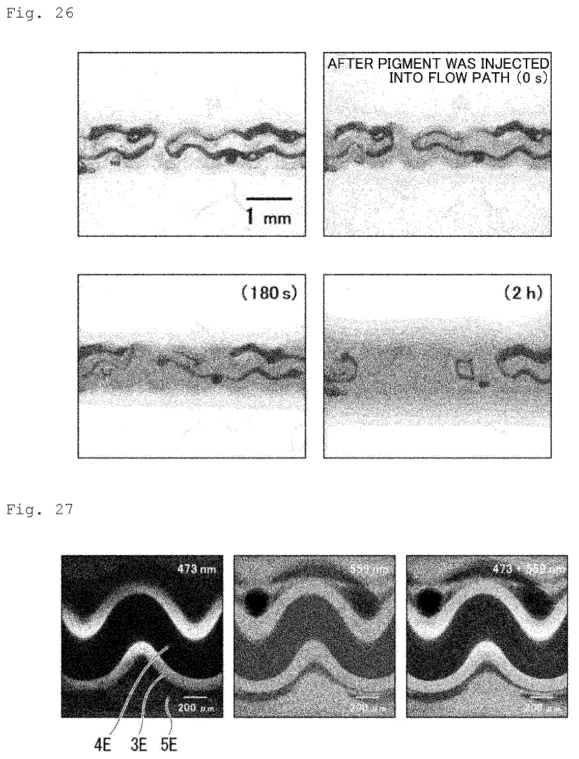

As shown in FIG. 24, in the hydrogel fluid device of Example 1, a hybrid flow path 4E was covered with a bulk gel 5E. In this case, in this manner, the hydrogel fluid device of Example 1 was able to bond PTFE as a liquid feed tube 6E with an adhesive 7E.

Conventional devices had problems that a tube bonding part was fragile and it collapsed when slight force was applied. On the other hand, in the hydrogel fluid device of Example 1, it was confirmed that, by applying the bulk gel, the structure of the flow path could be toughened and sufficient strength could be imparted to the bonding part.

In this manner, in the hydrogel fluid device produced in Example 1, the mechanical strength was excellent when the flow path (hybrid flow path) was processed.

As shown in FIG. 25, when a cross-sectional observation image was imaged using a confocal fluorescence microscope, the hybrid flow path 4E was confirmed as a flow path structure in which a film hydrogel 3E fluorescently stained with a fluorescent monomer was covered with the bulk gel 5E. In addition, it was confirmed that the hybrid flow path 4E was formed as a space above the glass substrate 2E.

Next, a 0.5 mg/ml rhodamine B solution was injected into the hydrogel fluid device of Example 1 from the liquid feed tube, and observation was performed from the upper surface of the hydrogel fluid device of Example 1 over time.

As shown in FIG. 26, a state in which red rhodamine B (small molecules) diffused from the flow path in the hydrogel fluid device in the order of the film hydrogel and the bulk gel as the times of 0 seconds, 180 seconds, and 2 hours passed after a pigment was injected into the flow path was observed.

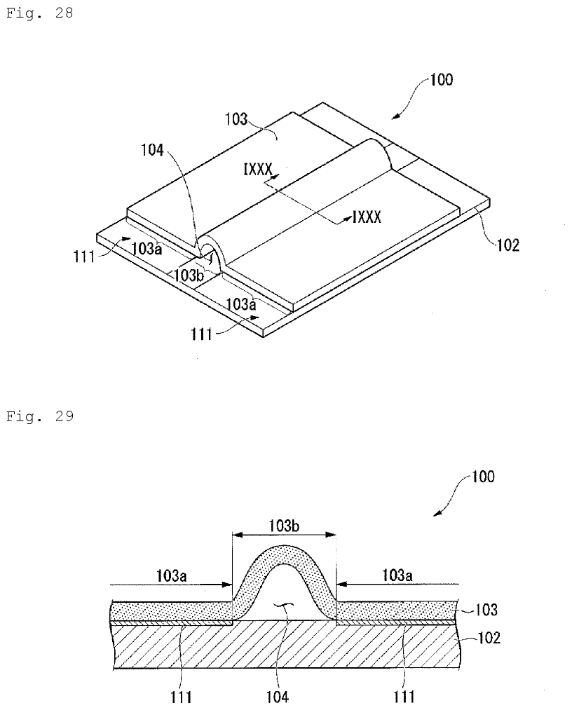

As shown in FIG. 27, when a cross-sectional observation image was imaged using a confocal fluorescence microscope, the film hydrogel 3E constituting the wall surface of the hybrid flow path 4E was fluorescently stained with green, and the inside of the bulk gel 5E also exhibited red fluorescence. In this manner, a state in which red rhodamine B permeated the wall surface (the film hydrogel 3E) of the hybrid flow path 4E fluorescently stained with green, and rhodamine B exhibiting red fluorescence diffused into the bulk gel 5E was observed.

### INDUSTRIAL APPLICABILITY

The hydrogel fluid device of the present invention includes a flow path having an arbitrary shape that can be formed by a simple method, and the material of the base component can be arbitrarily selected, and the mechanical strength is excellent when the flow path is processed.

According to the method of producing a hydrogel fluid device of the present invention, it is possible to obtain a hydrogel fluid device in which a flow path having an arbitrary shape can be easily formed, the material of the base component can be arbitrarily selected, and the mechanical strength is excellent when the flow path is processed.

The hydrogel fluid device according to the present invention is beneficial as a cell culture device, a reaction container and a sensing device that takes advantage of a diffusible flow path shape.

The hydrogel fluid device according to the present invention can be applied to a wide range of industrial fields such as tissue engineering and chemical engineering fields.

### REFERENCE SIGNS LIST

1 Hydrogel fluid device
2 Base component
3 Film hydrogel
4 Flow path (hybrid flow path)
5 Bulk gel
6 Tubular structure
7 Adhesive
11 Layer of adhesive functional group (first pattern)
30 First composition
31 First polymer material
32 Second composition
35 Sheet material
40 Resist layer
50 Low-swelling gel composition
51 Second polymer material
60, 61 Spacer
70, 71 Seal substrate
80 Layer of photopolymerization initiator
85 Mask material
90 Layer of gel-embedding polymer

1. A hydrogel fluid device, comprising:
a base component;
a film hydrogel that is provided in the base component and has an adhesive area that adheres to the base component and a non-adhesive area that does not adhere to the base component;
a flow path that is formed at an interface between the hydrogel and the base component when a first polymer material in the non-adhesive area is separated from the base component due to swelling of the first polymer material constituting the hydrogel; and
a bulk gel that covers one surface of the hydrogel outside the flow path and is composed of a second polymer material having a lower degree of swelling than the first polymer material.

2. The hydrogel fluid device according to claim 1,
wherein the non-adhesive area is arranged in a band shape inside the flow path, and
wherein the adhesive area is arranged on both sides of the non-adhesive area in an extension direction.

3. The hydrogel fluid device according to claim 1, further comprising
a tubular structure fixed between the base component and the hydrogel with an adhesive.

4. A method of producing a hydrogel fluid device, comprising:
providing a layer of a first polymer material constituting a hydrogel so that an adhesive area that adheres to a base component and a non-adhesive area that does not adhere to the base component are formed on one surface of the base component;
separating the first polymer material in the non-adhesive area from the base component by swelling the first polymer material, forming a flow path at an interface between the base component and the layer of the first polymer material, and forming the first polymer material as a film hydrogel;
covering the outside of the flow path with a bulk second polymer material having a lower degree of swelling than the first polymer material; and
swelling the second polymer material to form a bulk gel.

5. The method of producing a hydrogel fluid device according to claim 4,
wherein, when the layer of the first polymer material is provided on the one surface of the base component, a first pattern of adhesive functional groups is formed on the one surface of the base component,
wherein a first composition containing first polymerizable monomers having a functional group that forms a chemical bond with the adhesive functional groups is applied to the one surface, and
wherein the first polymerizable monomers are polymerized, the first composition is gelled, and thus the first composition is formed as the first polymer material.

6. The method of producing a hydrogel fluid device according to claim 4,
wherein, when the layer of the first polymer material is provided on the one surface of the base component, a layer of a polymerization initiator is formed on the one surface of the base component,
wherein a second composition containing second polymerizable monomers that form a chemical bond with the polymerization initiator is applied to one surface of the layer of the polymerization initiator, and
wherein, when the second polymerizable monomers are polymerized and the second composition is gelled, the adhesive area is formed in a part in which the layer of the polymerization initiator overlaps the second composition, and the second composition is formed as the first polymer material.

7. The method of producing a hydrogel fluid device according to claim 4,
wherein, when the layer of the first polymer material is provided on the one surface of the base component, a second pattern of gel-embedding polymers or adhesive molecules is formed on the one surface of the base component,
wherein a sheet material using the first polymer material as a forming material is arranged on the one surface of the base component in which the second pattern is formed, and
wherein the sheet material is brought into contact with the gel-embedding polymers or adhesive molecules.

8. The production method according to claim 4, further comprising
bonding a tubular structure to an opening surface of the flow path with an adhesive.
